(19) United States
(12) Patent Application Publication
(10) Pub. No.: US 2025/0010113 A1
(43) Pub. Date: Jan. 9, 2025

(54) Method and Apparatus for Fire Containment Device

(71) Applicant: Brian Tri Nguyen, San Jose, CA (US)

(72) Inventor: Brian Tri Nguyen, San Jose, CA (US)

(21) Appl. No.: 18/893,669

(22) Filed: Sep. 23, 2024

(51) Int. Cl. A62C 3/02

(52) U.S. Cl. CPC A62C 3/0207

(57) ABSTRACT

A fire containment device includes a fog or mist maker, which electrically connected to batteries and a power controller. The battery and power controller are electrically connected to a transformer, and one or more electrical outlet electrically connected to the transformer. One or more switches are built in the electrical circuit to turn on and off the power of fog or mist maker. A cover covers the frame to contain water or mixed water with fire extinguisher agent without leakage. And a transport assembly is used to transport the fire containment device by helicopter or crane truck. Fog or mist maker generates fog or mist from mixed water with extinguisher agent. The fog and mist carry fire extinguisher agent to the flame.

### BACKGROUND OF THE INVENTION

### 1. Field of the Invention

The present invention is in the field of fire containment and pertains particularly to methods and apparatus for using fog and mist to contain fire and preventing the spread of fire.

### 2. Description of Related Art

Every year, fires in the United States cause between $394 and $893 billion dollars in property damage, destroy 7 million acres of forests resulting in an average of 2,790 deaths and 13,250 injuries. California has more wildfire losses than any other state.

To contain a fire in the United States, firefighters primarily use methods like creating fire lines with heavy machinery, applying water or fire retardant directly to the flames using ground crews and aircraft, removing fuel by hand or bulldozer, and strategically setting controlled fires to deprive the wildfire of fuel.

The most commonly used methods are firefighters applying water directly to fire using water hose or helicopter. This causes more than 80 firefighter fatalities and 62,000 firefighter injuries on the job each year. According to Fireengineering.com, when water is applied directly to a fire, only 10% to 20% of the water is actually effective in extinguishing the flames. When firefighters apply water to a fire, it can cause significant water damage to a house, with a typical in substantial damage to floors, walls, ceilings, and belonging, far exceeding the water needed to just extinguish the flames. When helicopters are used for firefighting, only a small portion of the water effectively reaches the fire, and it is typically effective only over a limited area. The large amount of water becomes runoff or is absorbed into the ground.

Therefore to reduce losses of human lives and property damage, it is necessary to have an effective method to contain and prevent the fire.

### SUMMARY OF THE INVENTION

In one embodiment of the invention a Fire containment device is provided, comprising a fog or mist maker, which electrically connected to a battery and power controller, wherein the battery and power controller electrically connected to an electrical transformer. One or more electrical outlet connects to the transformer to provide oscillating two-directional alternating current (AC) power. One or more switches are built in electrical circuit to turn on and off the power of fog or mist maker. A cover covers the frame to contain water or mixed water with fire extinguisher agent without leakage. And a transport assembly is used to transport the Fire containment device by helicopter or crane truck.

Also in one embodiment the Fire containment device is further comprising one or more foot assemblies, which comprising two or more cylinder parts. These cylinder parts built on top each other allowing the foot assembly extending or contracting length. Also in one embodiment the foot assembly is further comprising a spring, wherein the foot assembly extending or contracting length automatically. Also in one embodiment the foot assembly is further comprising an electrical switch, when the foot assembly contracting length automatically turns on electrical power for the fog or mist maker.

Also in one embodiment the frame of Fire containment device is built from multiple parts. These parts connect each other with hinges, allowing the frame fold-in when the Fire containment device not in use.

Also in one embodiment the frame of Fire containment device further comprises channels for fog and mist, which is generated from fog or mist maker.

Also in one embodiment the Fire containment device further comprise water ports and fire extinguisher agent ports.

In another aspect of the invention a method for Fire containment device is provided, containing fire using fog or mist from water, wherein Fire containment device comprising (a) generating fog or mist from water using a fog or mist maker, (b) structuring the Fire containment device with a frame, (c) covering the frame with a cover, wherein the cover covering the frame to contain water or mixed water with fire extinguisher agent without leakage, (d) powering fog or mist maker with batteries or oscillating two-directional alternating current (AC) ports, (e) transporting the Fire containment device with a transport assembly by helicopter or crane truck.

In one embodiment of the method the Fire containment device further comprises one or more foot assemblies. This foot assembly is able to extend or contract length automatically. Also in one embodiment the foot assembly further comprises an electrical switch, when the foot assembly contracting length, it automatically turns on electrical power for the fog or mist maker.

Also in one embodiment of the method the frame of Fire containment device is built from multiple parts. These parts connecting each other with hinges, allowing the frame fold-in when the Fire containment device not in use for storage or transportation.

### BRIEF DESCRIPTION OF DRAWINGS

FIG. 1 is a perspective view of a Fire containment device according to an embodiment of the present invention.

FIG. 2 is another perspective view of the Fire containment device according to an embodiment of the present invention.

FIG. 3 is a section view of the Fire containment device through an electrical power lines according to an embodiment of the present invention.

FIG. 4 is a detail view A for the fog or mist maker area of FIG. 3.

FIG. 5 is a detail view B for an electrical power outlet of FIG. 2.

FIG. 6 is an exploded view of an electrical power outlet.

FIG. 7 is a section view of the Fire containment device through a water supply according to an embodiment of the present invention.

FIG. 8 is an exploded view of an electrical transformer and battery.

FIG. 9 is a detail view C for a foot assembly of Fire containment device of FIG. 7.

FIG. 10 is an electrical diagram according to an embodiment of the present invention.

FIG. 11 is a perspective view of the Fire containment device according to another embodiment of the present invention.

FIG. 12 is a perspective view of the frame of Fire containment device according to another embodiment of the present invention.

FIG. 13 is an exploded view of the frame of Fire containment device according to another embodiment of the present invention.

FIG. 14 is a section view of the Fire containment device through a water supply according to another embodiment of the present invention.

FIG. 15 is a perspective view of the frame in the fold-in position of Fire containment device according to another embodiment of the present invention.

FIG. 16 is a section view of the frame in the fold-in position of the Fire containment device through a water supply according to another embodiment of the present invention.

FIG. 17 is a perspective view of Fire containment device according to another embodiment of the present invention.

FIG. 18 is a section view of the Fire containment device through an electrical power lines according to another embodiment of the present invention.

FIG. 19 is a section view of the Fire containment device through a water supply according to another embodiment of the present invention.

### DETAILED DESCRIPTION OF THE INVENTION

The present invention provides methods and apparatus of Fire containment device. The Fire containment devise creates fog or mist from water. This fog and mist is used to extinguish the fire.

The fog and mist extinguish flames swiftly, safely and efficiently. With small amount of water, fog and mist can cover a large area of fire. Fog and water mist droplets vaporize, absorbing energy from the fire quickly, which prevents the fire from spreading. They displace oxygen area and cover burning material which blocks oxygen from entering the combustion zone.

The fire extinguisher agent (like foam, potassium acetate, potassium citrate, butyldiglycol, dish soap etcetera) is mixed with water. Fog and mist is generated from this mixed water will carry the fire extinguisher agent to the flame.

When there is a fire active, the Fire containment device is placed in the fire area, and the device automatically generates fog and mist covering the flame without presence of firefighter.

In place of a large wildfire, many Fire containment devices are placed around the fire. A wall of fog and mist is generated and cover the fire area.

For fire prevention, the Fire containment device generates fog and mist to cover and wet materials of the area. It prevents the fire from starting and spreading to the area.

The present invention is described in enabling detail in the following examples, which may represent more than one embodiment of the present invention.

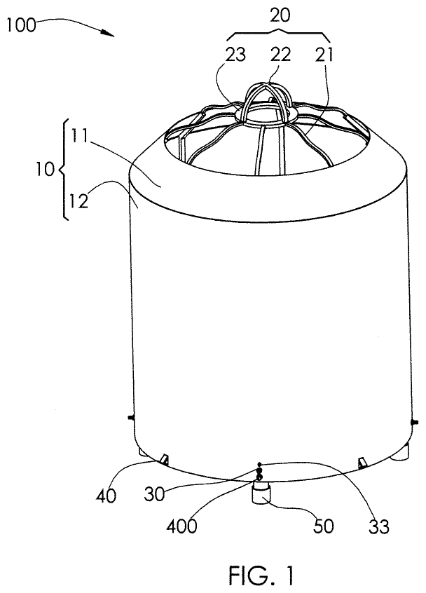

FIG. 1 is a perspective view of a Fire containment device 100 according to an embodiment of the present invention. Device 100 is in this example a Fire containment device. Fire containment device 100 comprises a cover 10, a transport assembly 20, 4 electrical outlets 40, 4 water ports 30, a fire extinguisher agent port 33, a main switch 400, 4 foot assemblies 50.

Cover 10 comprises top cover 11 and body cover 12. They can be made from non-flammable and non-water absorbent material like sheet metal, fiberglass etcetera. Cover 10 attaches and seals around the frame of the Fire containment device. It contains water inside without leakage.

Transport assembly 20 comprises a hook 22, a disk 23 and hangers 21. These are made from strong material, like metal wire rope, carbon fiber. Transport assembly 20 is used to transport the Fire containment device with helicopter or car.

Electrical outlet 40 is waterproof and fire resistant. There are 4 electrical outlets, 90 degree apart around of the Fire containment device, so it is easily to connect to the electrical power at any position of the device.

Water port 30 is used to connect to water supply. It is fire resistant. There are 4 water ports, 90 degree apart around of the Fire containment device, so it is easily to connect to the water supply at any position of the device.

Fire extinguisher agent port 33 is used to connect to the fire extinguisher agent. It is fire resistant.

Main switch 400 is used to turn on and off the electrical power of the Fire containment device. It is fire resistant.

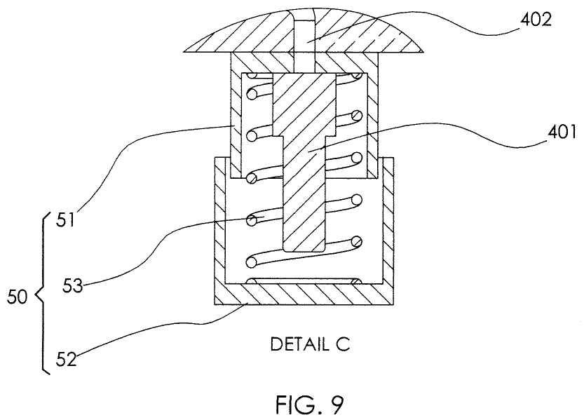

Foot assembly 50 is fire resistant and it is detailed in FIG. 9. There are 4 Food assemblies, 90 degree apart around of the Fire containment device.

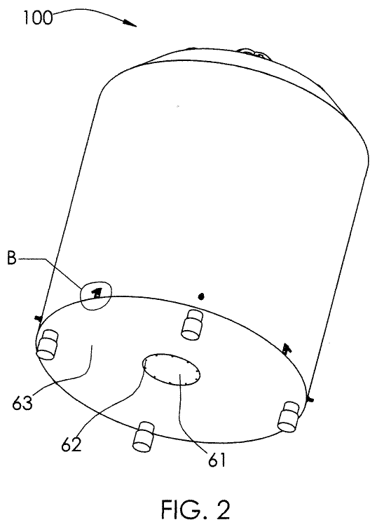

FIG. 2 is another perspective view of the Fire containment device 100 according to an embodiment of the present invention. In this example, the Fire containment device continually comprises a version-1-bottom 63, a cap 61, and screw cap 62. Version-1-bottom 63, cap 61 and screw cap 62 are made from fire resistant material.

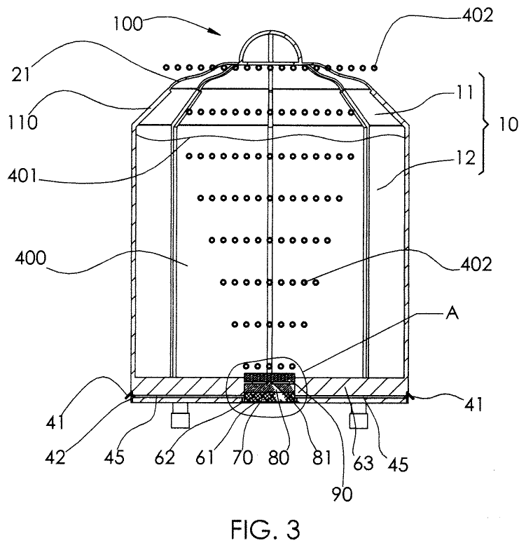

FIG. 3 is a section view of the Fire containment device 100 through an electrical power lines according to an embodiment of the present invention. In this example, a frame 110 is attached to version-1-bottom 63 and hanger 21. Frame 110 is a strong structure of the Fire containment device. Cover 10 covers around the frame 110 and keep water 400 inside without leakage. Water level 401 is high or low depends on what kind of transportation. Fire containment device is transported with helicopter, the water level 401 is low than with car.

An electrical outlet cover 41 covers the electrical outlet 42 to avoid water enter into the outlet 42. Electrical channel 45 is used to run electrical power line from outlet 41 to a transformer 70. Transformer 70 is used to decrease voltage and converts an oscillating two-directional alternating current (AC) into a single-directional direct current (DC). The transformer 70 connects to the battery and power controller 80. Battery and power controller 80 connects to fog or mist maker 90. A seal 81 seals connection between battery 80 and fog or mist maker 90. It does not allow water entering to the battery 80. For or mist maker generates fog or mist 402

Fog or mist 402 flow up to the water level 401 and get out of the Fire containment device. Fog or mist 402 gets into the air and cover the flame area. The fire extinguisher agent mixes with water. The fog or mist 402 carries the fire extinguisher agent to the flame.

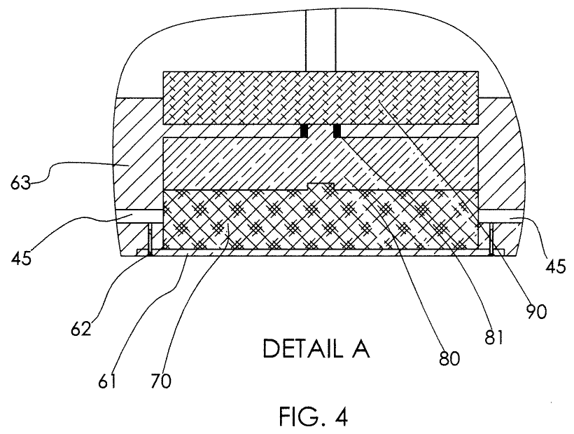

FIG. 4 is a detail view A for the fog and mist maker area of FIG. 3. Cap 61 is tighten and sealed to the version-1-bottom 63 with screws 62. It does not allow water enter to the transformer 70. The cap 61 keeps the transformer 70 and the battery 80 in the place.

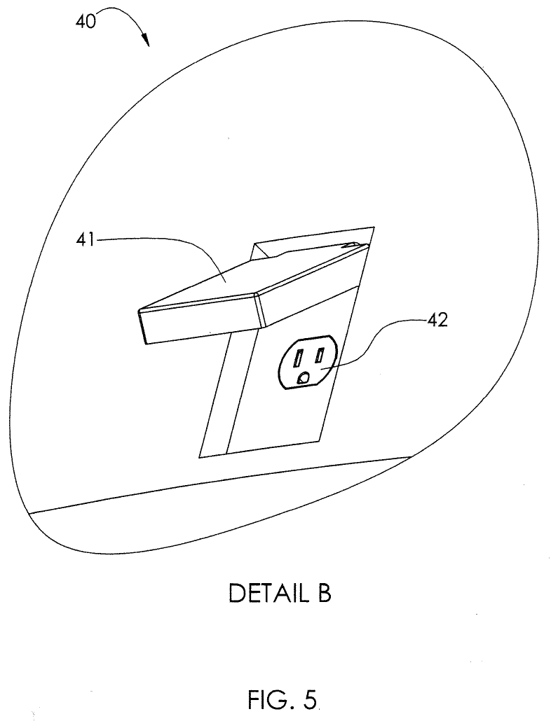

FIG. 5 is a detail view B for electrical power outlet 40 of FIG. 2. Electrical power outlet 40 is covered and sealed with cover 41. It does not allow water enter to the outlet 42 or electrical channel 45.

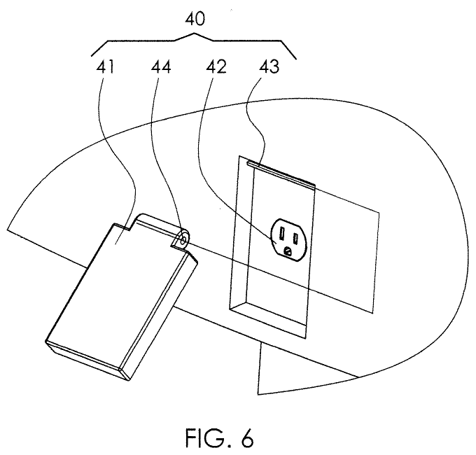

FIG. 6 is an exploded view of an electrical power outlet 40. Electrical outlet cover 41 is rotated around a pin 43 to open and close the outlet 42. Pin 43 connects to the outlet cover 41 through a hole 44.

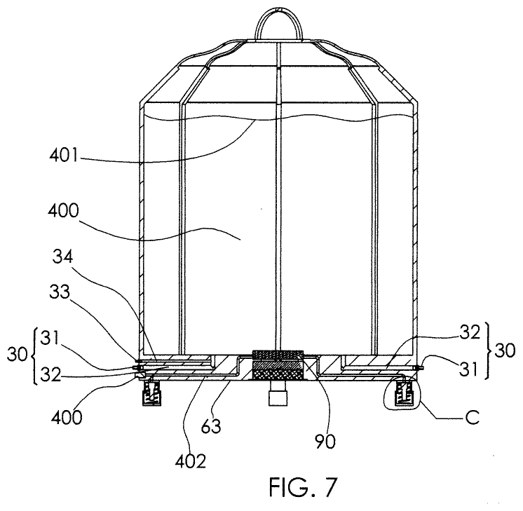

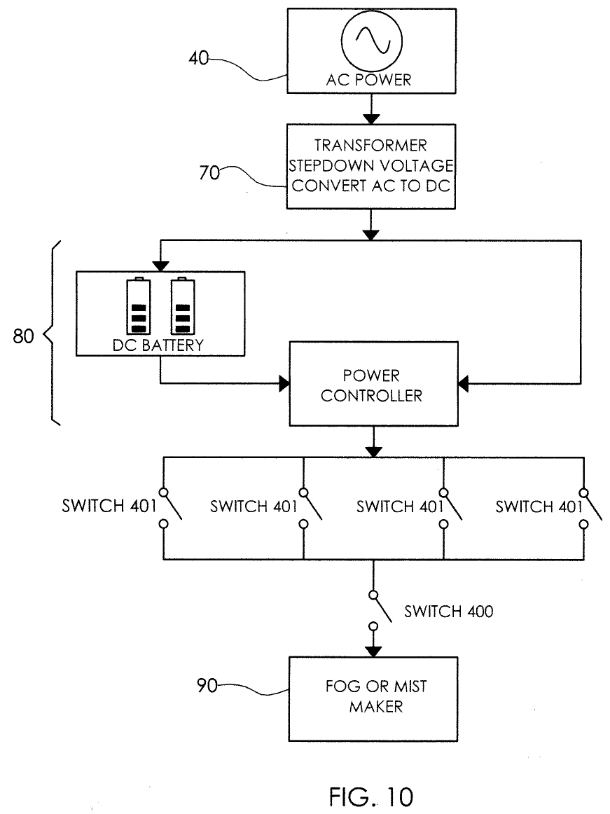

FIG. 7 is a section view of the Fire containment device 100 through a water supply according to an embodiment of the present invention. Water port 30 comprises a water fitting 31 and a water channel 32. Water channel runs water 400 from water supply to inside the Fire containment device. Fire extinguisher agent port 33 connects to a fire extinguisher agent channel 34. Channel 34 connects to water channel 32. Channel 34 runs fire extinguisher agent to the inside of Fire containment device to mix with water. Main switch 400 connects to fog or mist maker 90 through an electrical channel 402. Main switch 400 is used to turn on and off the fog or mist maker 90. An Electrical diagram is detailed on FIG. 10.

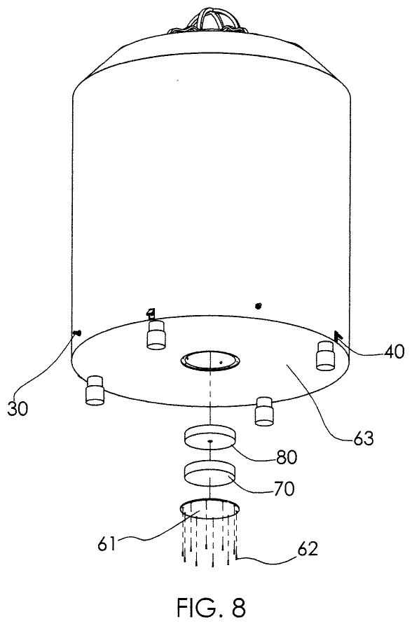

FIG. 8 is an exploded view of an electrical transformer 70 and a battery 80. The exploded view FIG. 8 shows how electrical transformer 70, battery 80, cap 61 and cap screws 62 are assembled in the version-1-bottom 63.

FIG. 9 is a detail view C for a foot assembly 50 of Fire containment device of FIG. 7. Foot assembly comprises an inner foot 51, an outer foot 52, a spring 53 and an electrical push button switch 401. Outer foot 52 and inner foot 51 can slide over each other. With this design, the Fire containment devise 100 can stand on 4 foot assemblies 50 over any ground conditions. When the Fire containment device is transported with helicopter or crane truck, the foot assemblies are not on the ground, the electrical push button switch 401 is at inactivated position, no electrical power goes to fog or mist maker. When the Fire containment device stand over the ground, the outer foot 52 push to the electrical push button switch 401 and activated the switch 401. Electrical power goes to the fog or mist maker and it generates fog and mist. Fog and mist get out of the Fire containment device and cover on flame area.

FIG. 10 is an electrical diagram according to an embodiment of the present invention. Electrical power supply from outlet 40 goes to transformer 70. The voltage is decreased. Oscillating two-directional alternating current (AC) is converted into a single-directional direct current (DC). The single-directional direct current (DC) charges battery and power the fog or mist maker 90 through switches 401 and main switch 400. If the Fire containment device works without Oscillating two-directional alternating current (AC), the power controller will use single-directional direct current (DC) from battery to power the fog or mist maker 90.

The main switch 400 is used to turn on and off the power for the Fire containment device. Only one of four switches 401 is activated or all four switches 401 are activated, the fog or mist maker 90 will be powered.

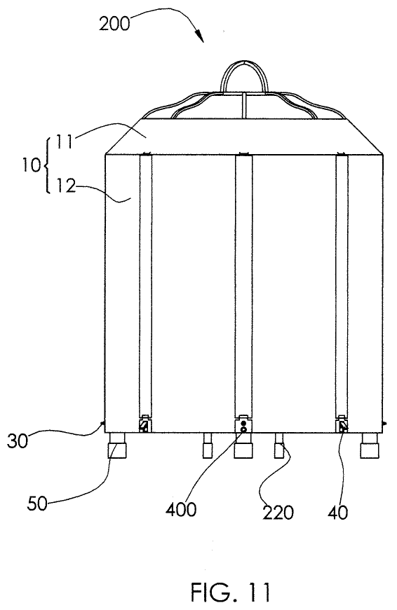

FIG. 11 is a perspective view of the Fire containment device according 200 to another embodiment of the present invention. In this example, Fire containment device 200 comprises 4 water ports 30, 4 foot assemblies 50, 4 center foot assemblies 220, main switch 400 and 4 electrical outlets 40.

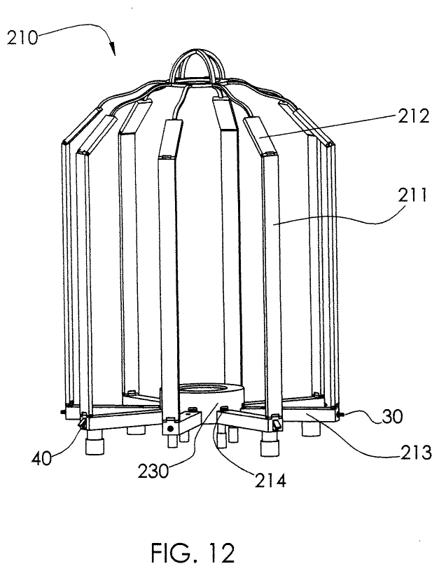

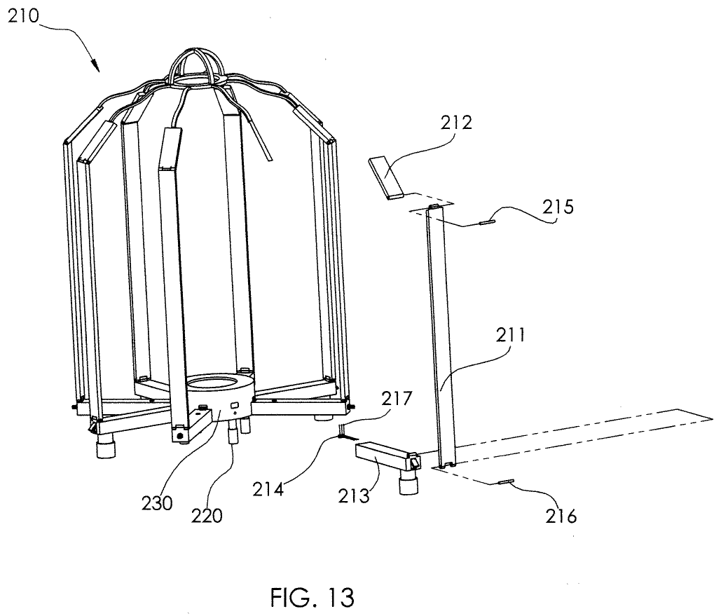

FIG. 12 is a perspective view of the frame 210 of Fire containment device 200 according to another embodiment of the present invention. Frame 210 comprises top frames 212, middle frames 211, bottom frames 213 and a version-2-bottom 230. These components connect together with hinges. The connections are detailed in FIG. 13.

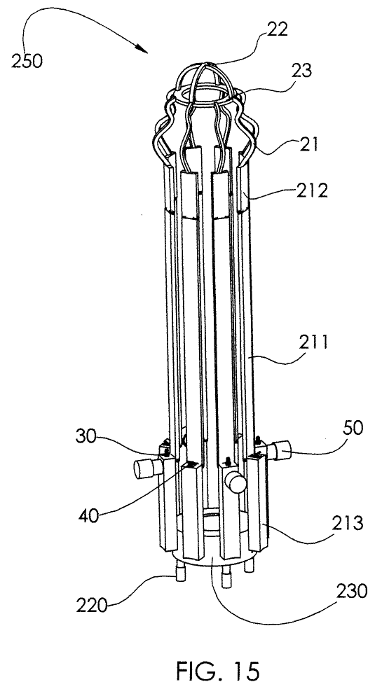

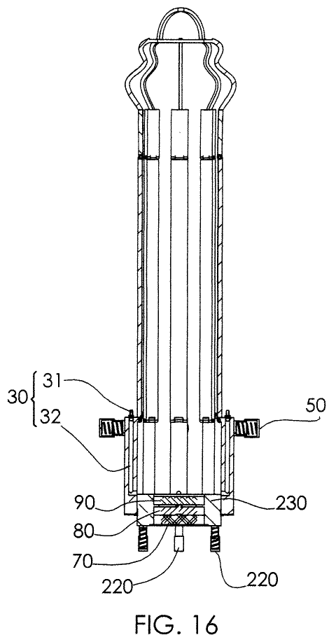

FIG. 13 is an exploded view of the frame 210 of Fire containment device 200 according to another embodiment of the present invention. The top frame 212 connects to middle frame 211 with a pin 215. The middle frame 211 connects to bottom frame 213 with a pin 216. The bottom frame 213 connects to version-2-bottom 230 with hinge 214 and screws 217. With these hinge connections, frame 210 can be folded in and it makes the Fire containment device 200 smaller when it is not in used. The frame 210 at the fold in position is detail in FIG. 15 and FIG. 16.

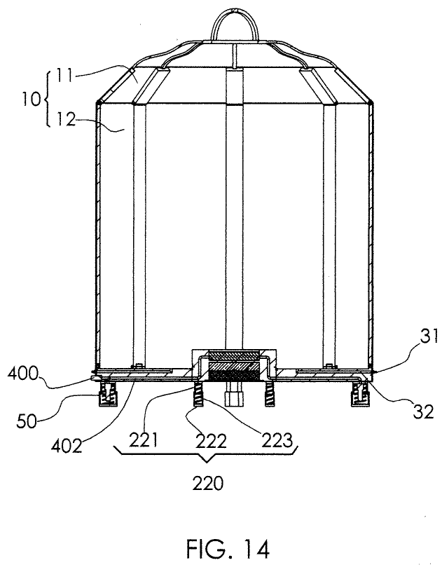

FIG. 14 is a section view of the Fire containment device 200 through a water supply according to another embodiment of the present invention. In this example, Fire containment 200 has 4 center foot assemblies 220 and 4 foot assemblies 50. The Fire containment 200 stands on the 4 center foot assemblies 220 when the Fire containment 200 is at fold-in position. The position is shown in FIGS. 15 and 16. The center foot assembly comprises a center inner foot 221, a center outer foot 222 and a center foot spring 223.

FIG. 15 is a perspective view of the frame in the fold-in position 250 of Fire containment device 200 according to another embodiment of the present invention. FIG. 15 shows the frame 150 without the cover 10. At the fold-in position, Fire containment device 200 stands only on 4 center foot assemblies. Dimensions of the Fire containment device 200 is a lot smaller for storage and transportation.

FIG. 16 is a section view of the frame in the fold-in position 250 of the Fire containment device 200 through a water supply according to another embodiment of the present invention. FIG. 16 shows the positions of transformer 70, battery and power controller 80 and fog or mist maker 90 inside the version-2-bottom 230.

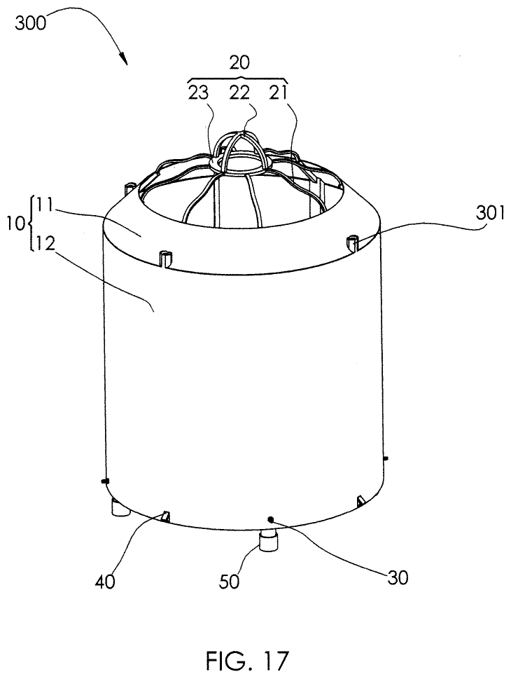

FIG. 17 is a perspective view of Fire containment device 300 according to another embodiment of the present invention. In this example, the Fire containment device 300 continuously comprises 4 fog and mist chimneys 301. The fog and mist chimneys 301 spread fog and mist more evenly around Fire containment device 300 and cover more evenly over the flame area.

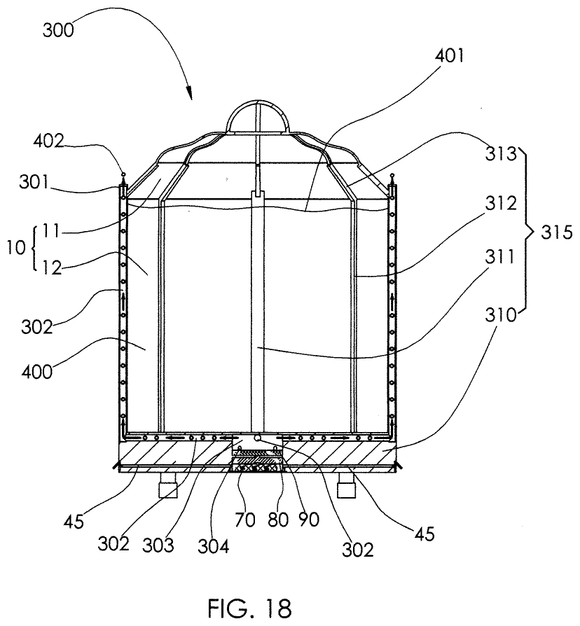

FIG. 18 is a section view of the Fire containment device 300 through an electrical power lines according to another embodiment of the present invention. Frame 315 comprises top frames 313, small middle frames 312, large middle frames 311 and a version-3-bottom 310. Cover 10 covers the frame 315 to contain water inside without leakage.

Water 400 comes inside chamber 303 through water channel 304. Fog or mist maker 90 generates fog and mist 402 in the chamber 303. Fog and mist 402 follow fog and mist channel 302 to the chimney 301. There are 4 fog and mist channels 302, 4 chimneys 301 and 4 water channel 304.

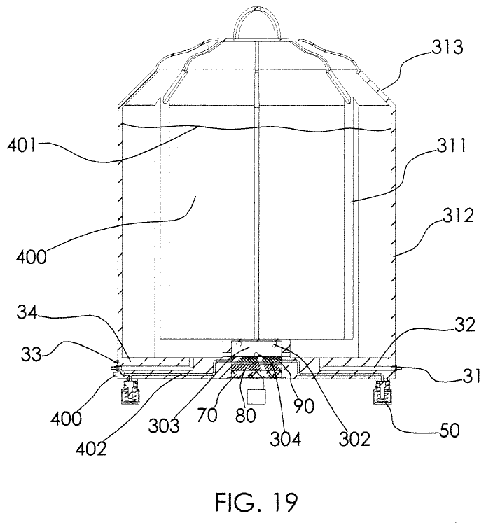

FIG. 19 is a section view of the Fire containment device 300 through a water supply according to another embodiment of the present invention. The main switch 400 connects to fog or mist maker 90 through the channel 402. Fire extinguisher agent port 33 connects to the channel 34 and connects to water channel 32 to mix the fire extinguisher agent with water inside Fire containment device 300. Fog and mist 402 carries fire extinguisher agent to flame area.

It will be apparent to one with skill in the art that the Fire containment device of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A apparatus comprising:
a fog or mist maker electrically connected to a battery and power controller; wherein the battery and power controller electrically connected to an electrical transformer;
one or more electrical outlet electrically connected to said transformer;
one or more electrical switches to turn on and off the electrical power for fog or mist maker;
a frame;
a cover wherein the cover covering said frame to contain water or mixed water with fire extinguisher agent without leakage;
a transport assembly wherein helicopter or crane truck can used said transport assembly to transport said apparatus.

2. The apparatus of claim 1 further comprising one or more foot assemblies; said foot assembly comprising two or more cylinder parts, wherein said cylinder parts built on top each other allowing said foot assembly extending or contracting length.

3. The apparatus of claim 2 wherein said foot assembly further comprising a spring, wherein said foot assembly extending or contracting length automatically.

4. The apparatus of claim 2 wherein said foot assembly further comprising an electrical switch, when said foot assembly contracting length automatically turn on electrical power for said fog or mist maker.

5. The apparatus of claim 1 wherein said transport assembly comprising a disk connecting a hook.

6. The apparatus of claim 1 wherein said frame built from multiple parts, said parts connecting each other with hinges, allowing said frame fold-in when it not in use.

7. The apparatus from claim 6 further comprising two or more sets foot assemblies of claim 2, one set foot assemblies for frame fold-in position and one or more set foot assemblies for open position.

8. The apparatus of claim 1 wherein said frame containing channels for fog and mist flowed from fog or mist maker to atmosphere.

9. The apparatus of claim 1 further comprising one or more water ports to supply water for fog or mist maker.

10. The apparatus of claim 1 further comprising one or more fire extinguisher agent port to supply fire extinguisher agent to mix with water.

11. A method for fire containment device comprising:
containing fire using fog or mist from water, wherein fire containment device comprising:
(a) generating fog or mist from water using a fog or mist maker;
(b) structuring said fire containment device with a frame;
(c) covering said frame with a cover, wherein the cover covering said frame to contain water or mixed water with fire extinguisher agent without leakage;
(d) powering fog or mist maker with batteries or oscillating two-directional alternating current (AC) ports;
(e) transporting said fire containment device with a transport assembly by helicopter or crane truck.

12. The method of claim 11 further comprising one or more foot assemblies, said foot assembly able extending or contracting length automatically.

13. The method of claim 12 wherein said foot assembly further comprising an electrical switch, when said foot assembly contracting length automatically turn on electrical power for said fog or mist maker.

14. The method of claim 11 wherein said frame built from multiple parts, said parts connecting each other with hinges, allowing said frame fold-in when said fire containment device not in use.

15. The method of claim 14 further comprising multiple sets foot assemblies, one set foot assemblies for said fire containment device at fold-in position and one or more set foot assemblies for fire containment device at open position.

16. The method of claim 11 wherein said frame containing channels for fog or mist flowed from fog or mist maker to atmosphere.

17. The method of claim 11 further comprising one or more water ports to supply water for fog or mist maker.

18. The method of claim 11 further comprising one or more fire extinguisher agent port to supply fire extinguisher agent to mix with water.
